(19) United States
(12) Patent Application Publication
(10) Pub. No.: US 2015/0144716 A1
(43) Pub. Date: May 28, 2015

(54) DEFLECTOR WITH A BUTTERFLY RIDGE FOR EVEN IRRIGATING OVER NON-CIRCULAR AREAS

(71) Applicant: SOVI SQUARE LTD., RISHON LEZIYON (IL)

(72) Inventors: Felix BARMOAV, RISHON LEZIYON (IL); Haim SLOTIN, Oranit (IL); Omri ABRAHAM, Ramat Ha'Sharon (IL)

(73) Assignee: SOVI SQUARE LTD., RISHON LEZIYON (IL)

(21) Appl. No.: 14/612,927

(22) Filed: Feb. 3, 2015

Related U.S. Application Data
(63) Continuation-in-part of application No. 13/585,626, filed on Aug. 14, 2012.
(60) Provisional application No. 61/935,481, filed on Feb. 4, 2014.
(60) Provisional application No. 61/523,598, filed on Aug. 15, 2011.
(60) Provisional application No. 61/536,008, filed on Sep. 18, 2011.
(60) Provisional application No. 61/591,925, filed on Jan. 29, 2012.
(60) Provisional application No. 61/591,927, filed on Jan. 29, 2012.

(51) Int. Cl. B05B 1/26

(52) U.S. Cl. CPC B05B 1/265
USPC 239/500

(57) ABSTRACT

An irrigating device and a deflector for even spraying of liquid across non-circular areas are presented. The irrigating device includes a base comprising at least a groove; a cap; and a deflector including at least a butterfly ridge, a groove, and a plurality of hydrodynamic ribs, wherein the butterfly ridge is structured with a continuous series of angles to allow equal quantity of liquid per distance on the radius and diagonal, wherein the groove is structured to allow full liquid coverage at a zero point, and wherein the plurality of hydrodynamic ribs are structured to control at least the irrigated distance.

### CROSS-REFERENCE TO RELATED APPLICATIONS

This application claims the benefit of U.S. Provisional Patent Application No. 61/935,481 filed on Feb. 4, 2014. This application is a continuation-in-part (CIP) of U.S. patent application Ser. No. 13/585,626 filed Aug. 14, 2012. The Ser. No. 13/585,626 application claims the benefit of U.S. provisional application No. 61/523,598 filed Aug. 15, 2011, U.S. provisional application No. 61/536,008 filed Sep. 18, 2011, U.S. provisional application No. 61/591,925, filed Jan. 29, 2012, and U.S. provisional application No. 61/591,927 filed Jan. 29, 2012. The contents of the above-referenced applications are herein incorporated by reference.

### TECHNICAL FIELD

The present disclosure relates generally to watering and sprinkler devices used to irrigate non-circular areas and, more particularly, to watering and sprinkler devices for uniform spray over non-circular areas.

### BACKGROUND

Spray type sprinklers are well known in the art of irrigation and are typically used for irrigating lawns and gardens of both residential and industrial properties. Most of the sprinklers provide various degrees of coverage of areas where typically the water spray pattern covers a circle or semi-circle coverage in a fan-type of spray.

Circular spraying around the sprinkler requires large sections of overlap between the sprinklers to ensure proper area coverage. The solutions discussed in the related art result in either wasted water or under watering because certain areas are not covered by the irrigation system. Existing solutions provide liquid spraying for non-circular shapes, particularly rectangles. However, these solutions are complex and provide far from appropriate coverage.

An example sprinkler 110 is shown in diagram 100A in FIG. 1A. The sprinkler 110 is structured to spray a square area 100. If the sprinkler 110 is adjusted such that it sprays along the length of the rectangular using spraying lines 140, the area sprayed 120 is smaller than the area of the square 100. This would result in several non-sprayed areas 130. In these areas 130, fire can continue to burn, thereby causing severe damage, or crops will be under-watered and wither. Conversely, in the case shown in FIG. 1B, the sprinkler 110 is adjusted to spray on the diagonal of the square 100. As a result, the entire square area is sprayed. However, additional areas 150 are sprayed as well, thereby resulting in over-spraying and waste of liquid.

FIGS. 2A and 2B show a solution attempting to increase the coverage range using sprinklers that allow not only adjustment of the sprinkling radius, but also of the angle of coverage. Specifically, in the cases shown in FIGS. 2A and 2B the angle of coverage of each sprinkler 210 is 90 degrees. In the case depicted in FIG. 2A, there are some areas 230 that are left unsprayed while in the case depicted in FIG. 2B there is an over-spraying of areas 250. Thus, none of these situations provide the desired outcome.

As a result of the deficiencies of the circular and semi-circular sprinkler solutions, attempts have been made to provide various rectangular sprinkling solutions. The solutions discussed in the related art typically use moving parts, are complex to operate, have a relatively low reliability, and are high in cost. Moreover, none of the existing solutions deal effectively with odd-shaped areas that require spraying. Sprinklers that spray square, rectangular, and partial surfaces thereof exist, but they cannot be adjusted because their spraying surfaces are determined during the manufacturing process and therefore are permanent. These permanent spraying patterns might cause over-spraying or under-spraying of areas as noted above.

It would be therefore advantageous to provide a solution of an irrigating device adjusted to cover a predetermined area pattern that is different from a circle or semi-circle.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include an irrigating device for even spraying of liquid across non-circular areas. The irrigating device comprises a base comprising at least a groove; a cap; and a deflector including at least a butterfly ridge, a groove, and a plurality of hydrodynamic ribs, wherein the butterfly ridge is structured with a continuous series of angles to allow equal quantity of liquid per distance on the radius and diagonal, wherein the groove is structured to allow full liquid coverage at a zero point, and wherein the plurality of hydrodynamic ribs are structured to control at least the irrigated distance.

Certain embodiments disclosed herein include a deflector. The deflector comprises a butterfly ridge structured with a continuous series of angles; and a plurality of hydrodynamic ribs structured to control at least an irrigated distance.

### BRIEF DESCRIPTIONS OF THE DRAWINGS

The subject matter disclosed herein is particularly pointed out and distinctly claimed in the claims at the conclusion of the specification. The foregoing and other objects, features, and advantages of various embodiments described herein will be apparent from the following detailed description taken in conjunction with the accompanying drawings.

FIG. 1A is a diagram of a square area with a sprinkler at its center having a radius coverage along the length of the square resulting in under irrigation.

FIG. 1B is a diagram of a square area with a sprinkler at its center having a radius coverage along the diagonal of the square resulting in over irrigation.

FIG. 2A is a diagram of a square area with two sprinklers placed at opposite corners of the square, each having a liquid flow radius extending from that sprinkler to the center of the square, and a 90 degree sprinkling limit resulting in under irrigation.

FIG. 2B is a diagram of a square area with sprinklers placed at opposite corners of the square, each having a liquid flow radius extending from that sprinkler to a corner of the square, and a 90 degree sprinkling limit resulting in over irrigation.

FIG. 3A is a bottom view of a deflector according to an embodiment.

FIG. 3B is a side view of a cross section via the deflector radius according to an embodiment.

FIG. 3C is an alternative side view of a cross section via the deflector diagonal according to an embodiment.

FIG. 4A is an expanded view of several hydrodynamic ribs featured on a deflector according to an embodiment.

FIG. 4B is a diagram illustrating the flow of liquid around and over a hydrodynamic rib.

FIG. 4C is a diagram illustrating the short and long distance arc of liquid flow upon exit from the deflector.

FIG. 5A is an isometric view of a deflector according to an embodiment.

FIG. 5B is a collection of close-up side views of a butterfly ridge according to an embodiment.

FIG. 6 is a diagram illustrating a cross section of a deflector featuring a butterfly ridge according to an embodiment.

FIG. 7 is a diagram illustrating the area of coverage according to an embodiment.

FIG. 8A is an exploded view of an irrigation assembly according to an embodiment.

FIG. 8B is a view of an irrigation assembly according to an embodiment.

FIG. 9 is diagram illustrating the area of coverage relative to zero point compensation according to an embodiment.

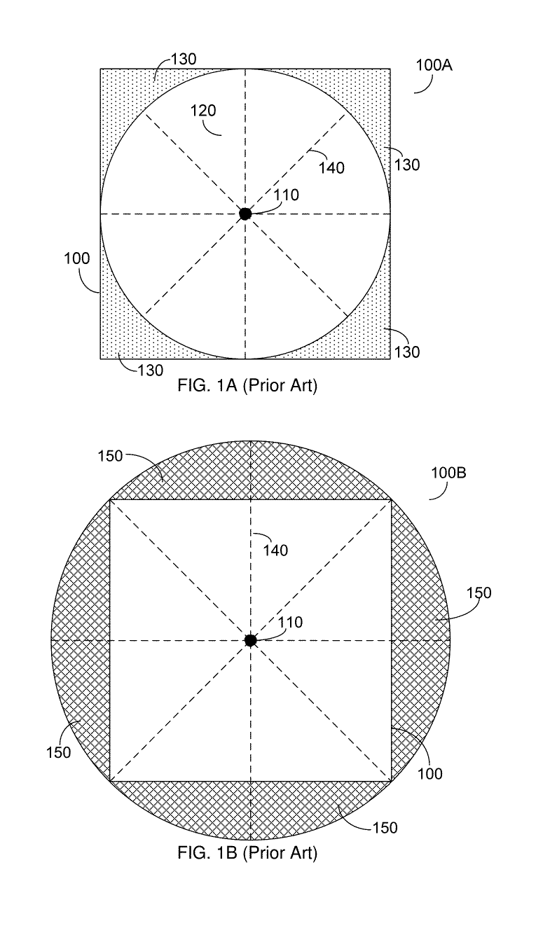

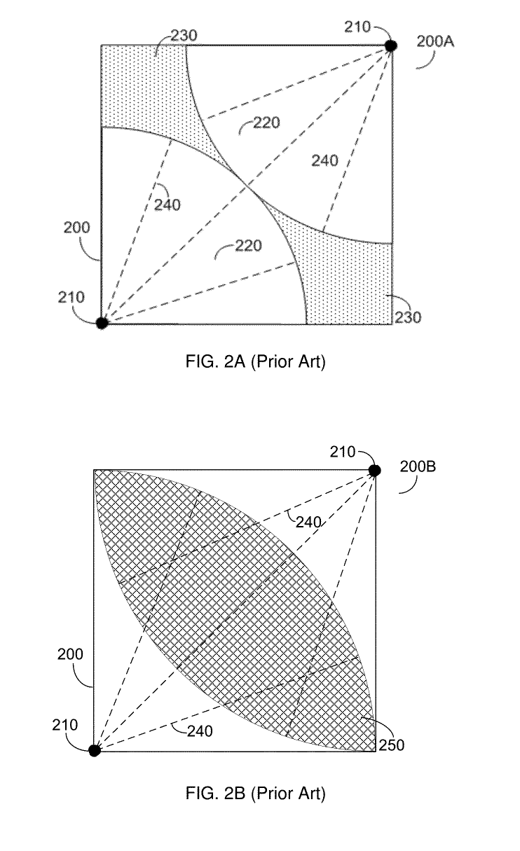

### DETAILED DESCRIPTION

The embodiments disclosed are only examples of the many possible advantageous uses and implementations of the innovative teachings presented herein. In general, statements made in the specification of the present application do not necessarily limit any of the various disclosed embodiments. Moreover, some statements may apply to some inventive features but not to others. In general, unless otherwise indicated, singular elements may be in plural and vice versa with no loss of generality. In the drawings, like numerals refer to like parts through several views.

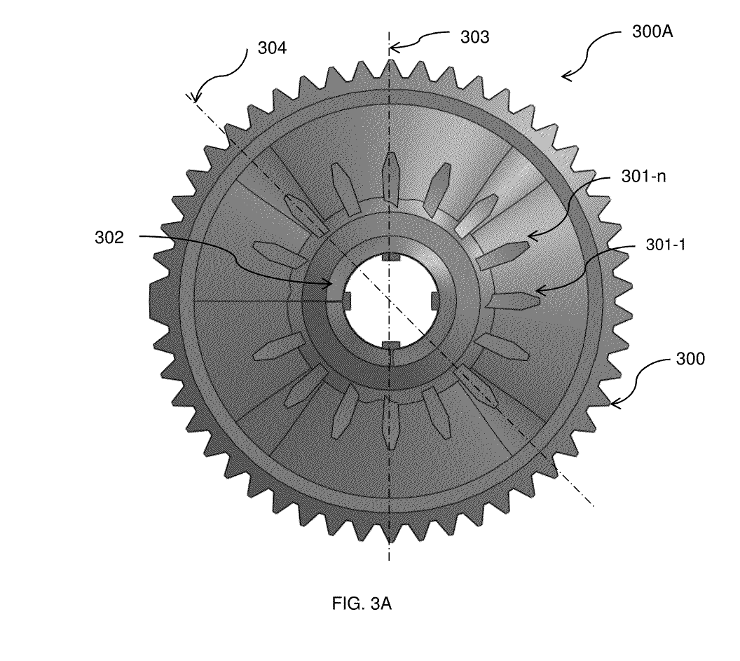

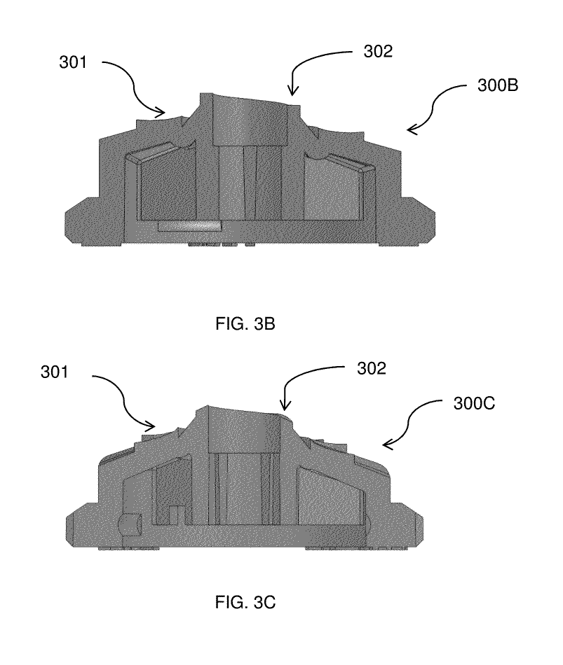

FIGS. 3A, 3B, and 3C illustrate an exemplary and non-limiting bottom view 300A and side views 300B and 300C, respectively, of a deflector 300 designed according to an embodiment. The deflector 300 is designed to permit the flow of liquid through and out of an irrigation device. Detailed description of the use of a deflector to permit liquid to flow through and out of an irrigation device can be found in U.S. patent application Ser. No. 13/585,626, filed Aug. 14, 2012 and in U.S. patent application Ser. No. 13/585,635, filed Aug. 14, 2012, both assigned to common assignee, which are hereby incorporated by reference for all the useful information they contain.

To aid in ensuring uniform spray over portions of the area of coverage that are closer to the liquid outlet and portions of the area of coverage that are farther than the liquid outlet, hydrodynamic ribs 301-1 through 301-n (hereinafter referred to as a hydrodynamic rib 301 or hydrodynamic ribs 301) are utilized. Additionally, the deflector 300 includes a butterfly ridge 302 that liquid encounters upon exiting the deflector 300. The deflector 300 is also structured to align with a radius cross section 303 and a diagonal cross section 304. In another embodiment, the deflector 300 may be configured to align with more than one radius cross section and/or more than one diagonal cross section. Radius cross section 303 corresponds to radii distances 702 (see FIG. 7), as discussed further below. Diagonal cross section 304 corresponds to diagonal distances 703, (see FIG. 7) as discussed further below.

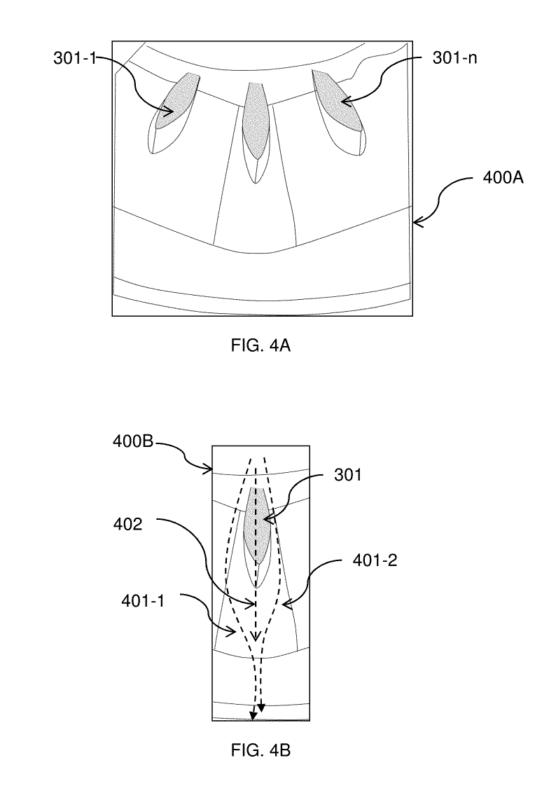

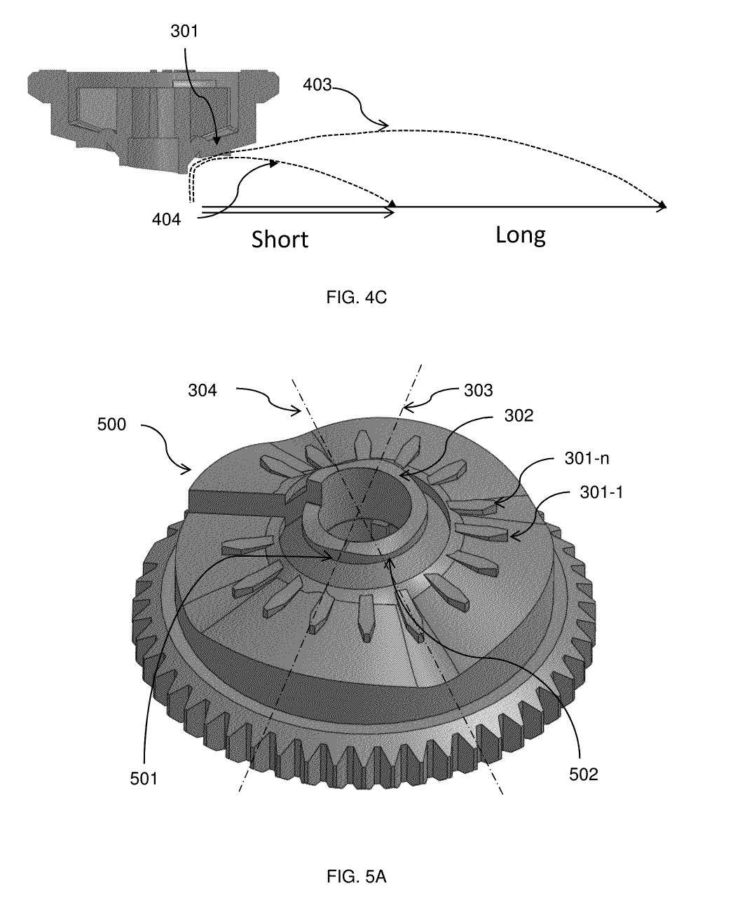

FIG. 4A illustrates an enlarged view 400A of the hydrodynamic ribs 301 according to one embodiment. A schematic diagram 400B shows the flow of liquid over and around a hydrodynamic rib 301. As liquid exits the deflector 300 (referenced by 300A, 300B, or 300C), the liquid will encounter one of the hydrodynamic ribs 301.

FIG. 4B illustrates the flow of liquid around a hydrodynamic rib according to an embodiment. When the liquid exits the deflector 300, the liquid will flow around a hydrodynamic rib 301, thereby traveling along one of path 401-1 or path 401-2. Alternatively, the liquid can flow over the hydrodynamic rib 301, thereby traveling along path 402. Liquid traveling along either path 401-1 or path 401-2 typically travels farther during free fall, thereby primarily covering distances farther away from the irrigation device. In contrast, the liquid traveling along path 402 typically glides over the rib and is redirected, such that the initial angle of flow of liquid traveling along path 402 after exiting the irrigation device is lower than the initial angle of flow of liquid traveling along either of path 401-1 or 401-2.

A non-limiting example for the hydrodynamics of the disclosed deflector 300 is shown in FIG. 4C. The liquid traveling along either path 401-1 or 401-2 (see FIG. 4B) may move in an arc 403 that is about 30 degrees above an arc 404 moved in by liquid traveling along path 402. That is, the angle of hydrodynamic rib above the surface of the deflector 300 forces the liquid to cover a shorter distance from the irrigation device.

It should be noted that hydrodynamics of the disclosed deflector 300 provide full coverage of the irrigated area, as liquid flowing along the paths 401-1 and 401-2 eventually converge. It should be further noted that without the hydrodynamic shape of the rib 301, the liquid would likely flow only to the short distance, thereby creating slits or gaps of unirrigated areas. In an embodiment, the hydrodynamic rib 301 is shaped in such way that the base and the width of the hydrodynamic rib 301 are dimensioned as a function of the amount of liquid required to flow over the hydrodynamic rib 301. Therefore, controlling these dimensions allow control of the amount of liquid that will be irrigated in the short distance; the wider the hydrodynamic rib 301 is the more liquid exits the hydrodynamic rib 301, and vice versa.

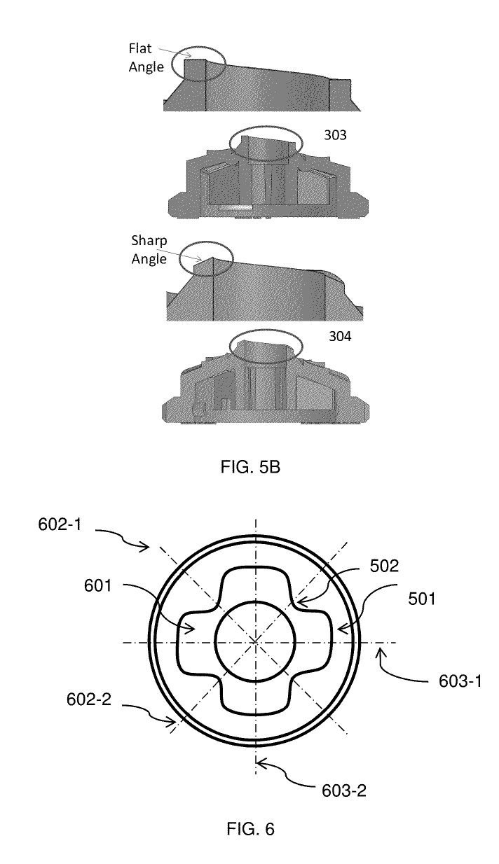

FIG. 5A illustrates an exemplary and non-limiting isometric view 500 of a deflector 300 according to an embodiment. As discussed above, the structure of the deflector, according to one embodiment, includes hydrodynamic ribs 301 to alter the flow of liquid out of the irrigation device.

Further, the embodiment of the deflector includes a butterfly ridge 302. The butterfly ridge 302 includes a continuous series of angles, including one or more sharp angled portions 502 and one or more flat angled portions 501. Each sharp angled portion 502 features an angle along the butterfly ridge 302 that is steeper than the angle along the butterfly ridge 302 of each flat angled portion 501 (i.e., the angles of the ridge peak at the sharp angled portion(s) and depress at the flat angled portions).

As a non-limiting example, a sharp angled portion 502 features an angle along the butterfly ridge 302 of 60 degrees and a flat angled portion 501 features an angle along the butterfly ridge 302 of 0 degrees. As another non-limiting example, a sharp angled portion 502 features an angle along the butterfly ridge 302 of 50 degrees and a flat angled portion 501 features an angle along the butterfly ridge 302 of 5 degrees. Each of the flat angled portions 501 corresponds to a radius cross section 303, and each of the sharp angled portions 502 corresponds to a diagonal cross section 304.

Through the variation of sharp angled portions 502 and flat angled portions 501, the butterfly ridge 302 causes the amount of liquid traveling out of the sprinkler to increase or decrease, respectively. Specifically, there will be more liquid at the diagonal and less liquid at the radius. It should be appreciated that the disclosed irrigation device is shaped in such a way to allow a uniformity of spraying of liquid over the irrigated area. As noted above, controlling locally the amount of liquid crossing the radius and diagonal and the hydrodynamic ribs 301 covers the short distance and at the same time allows liquid to travel to the long distance as well at the places where a hydrodynamic rib 301 exists.

FIG. 5B illustrates a collection of exemplary and non-limiting close-up side views of the butterfly ridge 302. As discussed hereinabove with respect to FIG. 5A, each of the flat angled portions 501 corresponds to a radius cross section 303, and each of the sharp angled portions 502 corresponds to a diagonal cross section 304. FIG. 5B illustrates the structure of the angles on the butterfly ridge 302. Specifically, the flat angle 501 is a uniform lip of the butterfly ridge 302 located along the radius cross sections 303 and the sharp angle 502 is an angled lip of the butterfly ridge 302 located along the diagonal cross sections 304.

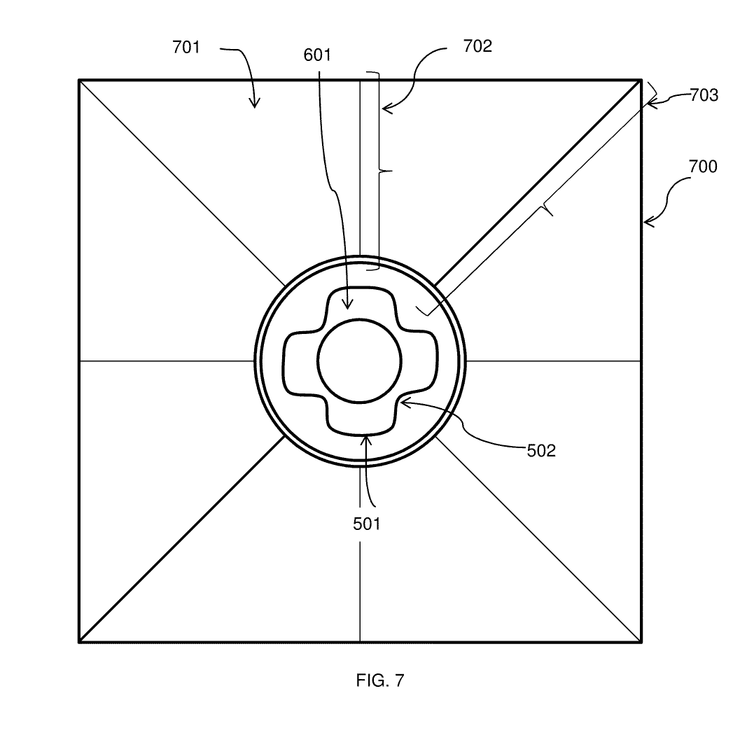

FIG. 6 illustrates an exemplary and non-limiting schematic bottom view diagram 600 of an irrigation device featuring a butterfly ridge 601 according to one embodiment. In this embodiment, the desired area of coverage is square shaped and the butterfly ridge 601 having a pattern including four (4) flat angles 501 and four (4) sharp angles 502 is utilized to compensate the amount of liquid for the desired square shaped spread of liquid. Each of the flat angles 501 lies on the intersection between butterfly ridge 601 and either of radius cross section 603-1 or radius cross section 603-2. Each of the sharp angles 502 lies on the intersection between butterfly ridge 601 and either of diagonal cross section 602-1 or diagonal cross section 602-2.

FIG. 7 shows a schematic diagram illustrating the area of coverage 700 according to the embodiment presented in FIG. 6. As noted above, as liquid escapes the deflector, the liquid encounters butterfly ridge 601, comprising flat angles 501 and sharp angles 502. Flat angles 501 are aligned with four radii 702, while sharp angles 502 are aligned with four diagonals 703.

It should be noted that the length of each diagonal 703 is greater than the length of each radius 702. As liquid flows over the flat angles 501 before exiting the irrigation device, the amount of liquid decreases. Consequently, a lesser amount of liquid flows over flat angles 501 than the amount of liquid over radius 702. In contrast, the amount of liquid flowing over sharp angles 502 increases, thereby causing more liquid to travel over the diagonal 703. As a result, the amount of liquid per distance is balanced and equal for the diagonal and for the radius, thus causing improved irrigated uniformity.

As discussed with respect to FIGS. 3A and 3B, in an embodiment, hydrodynamic ribs (e.g., ribs 301) may be used to vary the distance traveled by liquid moving in any particular direction. Due to the variations in the local amount of liquid by the butterfly ridge 601 and the variation in distance traveled by liquid in a given direction generated by the hydrodynamic ribs 301, liquid may be sprayed uniformly throughout area 701.

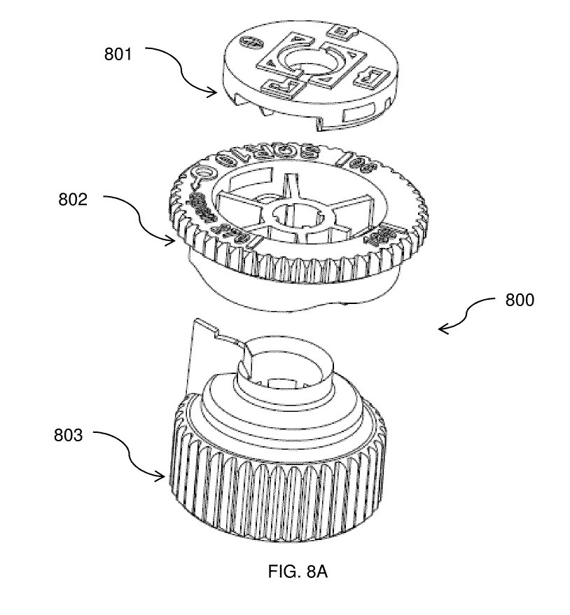

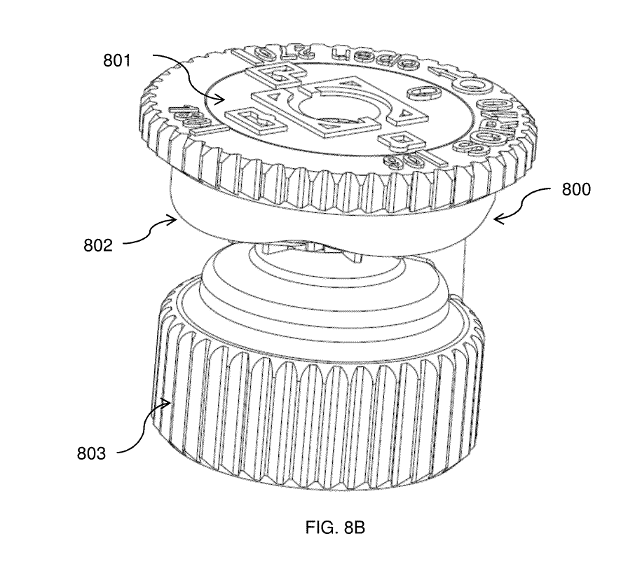

Various disclosed embodiments herein further include a cap placed on an irrigation device. The cap is used to distinguish irrigation device models of the same series from each other. FIG. 8A illustrates an exemplary and non-limiting exploded view of an irrigation device 800 having a cap 801, a deflector 802, and a base part 803. Further, FIG. 8B illustrates a view of the assembled parts of the irrigation device 800. In an embodiment, the cap 801 is color coded (i.e., the cap has a color corresponding to a particular model).

As a non-limiting example, a cap 801 corresponding to an irrigation device 800 for spraying liquid distances of 10 feet may be red, while a cap 801 corresponding to irrigation device 800 for spraying liquid distance of 12 feet may be green.

In various embodiments, the cap 801 may be poka-yoke coded such that the cap 801 and/or other components would not be mistakenly excluded from the irrigation device 800 during assembly. In yet another embodiment, the cap 801 may be color-coded in association with an irrigation device 800 to indicate the shape of the area of coverage intended to be sprayed during the associated irrigation device's use.

In an embodiment, a user may rotate the deflector 802 relative to the base 803 of the irrigation device 800. As the user rotates the deflector 802, the opening arc of liquid flow may increase or decrease according to the respective direction (clockwise or counterclockwise) that the user rotates the deflector 802. In an embodiment, the deflector 802 provides sensory feedback to the user upon rotation beyond predesignated arcs (e.g., 90 degrees, 180 degrees, 270 degrees, 360 degrees, and so on). In a further embodiment, the sensory feedback may be, but is not limited to, a “click” sound or “click feeling” when reaching predesignated arcs (e.g., 90 degrees, 180 degrees, 270 degrees, 360 degrees, and so on) and resistance to movement until a certain amount of rotational force is exerted upon the deflector 802.

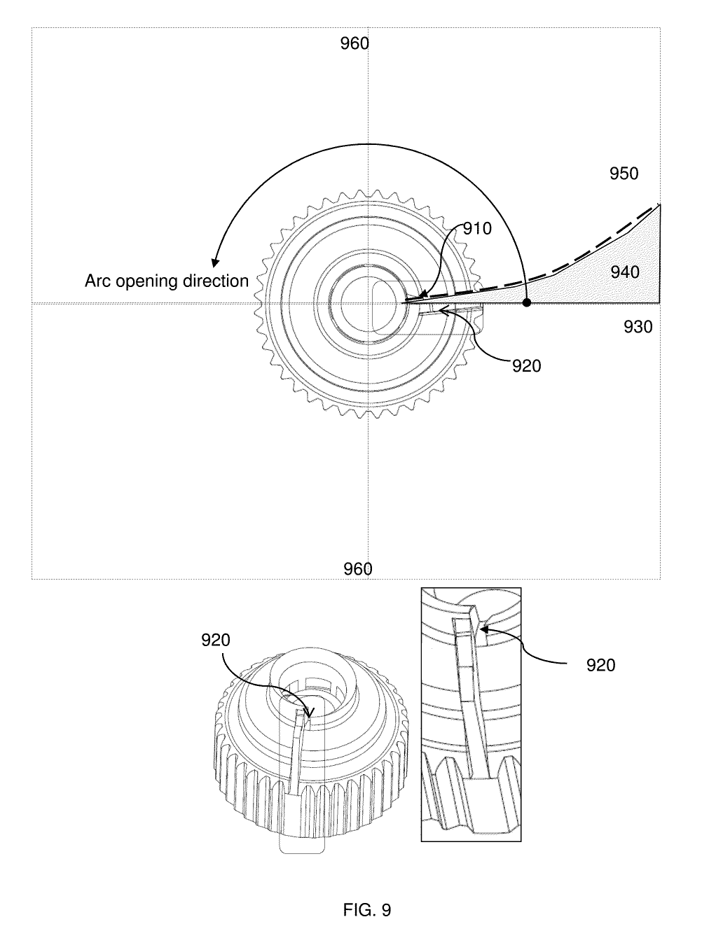

FIG. 9 illustrates an exemplary and non-limiting view of the effects of zero point compensation on the flow of a liquid from an irrigation device. The zero point 910 is the origin point of the opening arc of liquid flow by the irrigation device 800. The addition of a groove 920 in the base 803 allows full liquid coverage from the zero point 910 up to a destination point 930. Without the groove 920 the highlighted area 940 will miss liquid because the path of liquid will approximately follow the dashed line 950. Rotational movement of the irrigation device 800 along an arc opening direction will fill in an entire square area 960 around the irrigation device 800.

For example, the liquid used for irrigation is water and the desired irrigation distance is ten feet. To reach this distance, the width of the groove may be 0.65 mm. The combination of the water pressure (2 bar) with the width of the groove project the water within the shaded area up to ten feet.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An irrigating device for even spraying of liquid across non-circular areas comprising:
a base comprising at least a groove;
a cap; and
a deflector including at least a butterfly ridge, and a plurality of hydrodynamic ribs, wherein the butterfly ridge is structured with a continuous series of angles to allow equal quantity of liquid per distance on the radius and diagonal, wherein the groove is structured to allow full liquid coverage at a zero point, and wherein the plurality of hydrodynamic ribs are structured to control at least the irrigated distance.

2. The irrigating device of claim 1, wherein the plurality of hydrodynamic ribs is above a surface of the deflector, thereby forcing the liquid to cover a shorter and longer distance from the irrigating device.

3. The irrigating device of claim 1, wherein a base and a width of each of the plurality of the hydrodynamic ribs is dimensioned as a function of at least the quantity of liquid of the irrigated distance.

4. The irrigating device of claim 1, wherein the continuous series of angles of the butterfly ridge includes at least one sharp angled portion and at least one flat angled portion.

5. The irrigating device of claim 4, wherein the at least one sharp angled portion features an angle along the butterfly ridge that is steeper than the angle along the butterfly ridge of the at least one flat angled portion.

6. The irrigating device of claim 4, wherein the at least one sharp angled portion causes the amount of liquid traveling out of the irrigating device to increase at the diagonal.

7. The irrigating device of claim 4, wherein the at least one flat angled portion causes the amount of liquid traveling out of the irrigating device to decrease at the radius.

8. The irrigating device of claim 4, wherein the at least one flat angled portion corresponds to a radius cross section of the deflector and the at least one sharp angled portion corresponds to the diagonal cross section of the deflector.

9. The irrigating device of claim 8, wherein the butterfly ridge includes four flat angles and four sharp angles for a rectangle or square spray pattern.

10. The irrigating device of claim 1, wherein the butterfly ridge and the plurality of hydrodynamic ribs are configurable to cause liquid to be sprayed uniformly throughout an area.

11. The irrigating device of claim 1, wherein the cap is color coded to indicate at least one of: spraying distance and shape of the area of coverage.

12. A deflector comprising:
a butterfly ridge structured with a continuous series of angles; and
a plurality of hydrodynamic ribs structured to control at least an irrigated distance.

13. The deflector of claim 12, wherein the deflector is structured to connect to a base, the base comprising at least a groove.

14. The deflector of claim 12, wherein the continuous series of angles of the butterfly ridge includes at least one sharp angled portion and at least one flat angled portion.

15. The deflector of claim 14, wherein the at least one sharp angled portion features an angle along the butterfly ridge that is steeper than the angle along the butterfly ridge of the at least one flat angled portion.

16. The deflector of claim 14, wherein the at least one flat angled portion corresponds to a radius cross section of the deflector and the at least one sharp angled portion corresponds to the diagonal cross section of the deflector.

17. The deflector of claim 16, wherein the butterfly ridge includes four flat angles and four sharp angles for a rectangle or square spray pattern.

18. The deflector of claim 12, wherein the butterfly ridge and the plurality of hydrodynamic ribs are configurable to cause liquid to be sprayed uniformly throughout an irrigated area.
